(19) United States
(12) Patent Application Publication
(10) Pub. No.: US 2013/0238514 A1
(43) Pub. Date: Sep. 12, 2013

(54) SYSTEM FOR THE INTERCHANGE OF GARNISHMENT REQUESTS AND RESPONSES AMONG COLLECTION ATTORNEYS AND POTENTIAL GARNISHEES

(71) Applicants: Emily Balogh, Minneapolis, MN (US); James Balogh, Tuscon, AZ (US); Barry Johnson, Minneapolis, MN (US); Heidi Staloch, St. Paul, MN (US)

(72) Inventors: Emily Balogh, Minneapolis, MN (US); James Balogh, Tuscon, AZ (US); Barry Johnson, Minneapolis, MN (US); Heidi Staloch, St. Paul, MN (US)

(21) Appl. No.: 13/787,306

(22) Filed: Mar. 6, 2013

Related U.S. Application Data
(60) Provisional application No. 61/607,972, filed on Mar. 7, 2012.

(51) Int. Cl. G06Q 50/18; G06Q 40/00

(52) U.S. Cl. CPC G06Q 50/18; G06Q 40/00
USPC 705/311

(57) ABSTRACT

A data processor at a central location includes a central processing unit, a receiving component to receive garnishments, an importer which writes the garnishments to a central database, a transmitting component which sends the garnishments to participating garnishees, a second receiving component to receive responses to garnishments, a validation component to insure the responses meet basic standards of compliance and completeness, a business rules engine within the validation component to apply jurisdiction-specific standards to the validation, a second importer which writes the garnishee responses to the central database, and a second transmitting component.

### RELATED APPLICATION

This application claims priority to U.S. Provisional Application Ser. No. 61/607,972, filed Mar. 7, 2012, entitled “A SYSTEM FOR THE INTERCHANGE OF GARNISHMENT REQUESTS AND RESPONSES AMONG COLLECTION ATTORNEYS AND POTENTIAL GARNISHEES”, which is incorporated herein by reference in its entirety.

### FIELD

The present invention relates generally to the collection, validation, harmonization, and distribution of summonses, orders, demands, or requests of attachment (“garnishments”) of assets held in a bank or other financial institution or of wages earned, or to be earned, but not yet disbursed and the collection, validation and distribution of affirmative and negative responses to those orders. Specifically, the invention relates to methods and apparatus for electronic collection of account or wage garnishment information; translation of the information into a common format; notification of pending garnishments; a combination of interfaces, both machine (including batch and interactive) and human, for recipients to review and respond to the garnishments; the collection and validation of these responses; and the distribution of these responses to the entities which originally provided the garnishment.

### BACKGROUND

If a creditor wishes to collect a court-ordered judgment from a particular individual, the creditor may obtain an order directing a third party which holds or owes, or expects to hold or owe, funds to the particular individual, subject to the specific considerations of various state laws, and garnish those funds. Often the most common sorts of third parties to whom these garnishments are directed are banks or other deposit-holding financial institutions, and individuals' presumed employers. Depending on the laws of the state in which the garnishment is being pursued as well as the accuracy of any information the creditor has obtained regarding an individual's active banking and employment relationships, the garnishment may be directed to one or more third parties for response.

These garnishments can then be reviewed by the putative garnishee who can then take appropriate action, the specific details of which vary across jurisdiction, but which generally include verifying that the individual in question is an account holder or employee and that funds in that account or wages are properly subject to garnishment, embargoing those funds or some portion of those wages subject to the possibility of future release to the creditor, notifying the individual of the garnishment of the funds or wages, and notifying the creditor of the results of the aforementioned actions. The putative garnishee is required to respond to all attempts to garnish, in a timely manner as defined by the jurisdiction governing the attempted garnishment, meaning that larger institutions must often comply with the rules of multiple jurisdictions within a single operation (e.g., a single back-office operation).

Each of the parties can independently keep track of their portions of the above process, which has historically been implemented via paper-based systems. Banks and employers having account holders and employees in multiple jurisdictions are faced with complying with rules, which vary from jurisdiction to jurisdiction. These factors render the process complex and difficult to manage for all parties involved.

The Minnesota Department of Revenue provides an electronic portal for banks to acquire garnishments for unpaid state taxes. The Michigan Department of Revenue provides a way for creditor garnishments to be taken out of state tax refunds.

### SUMMARY

A data processor at a central location includes a central processing unit, a receiving component to receive garnishments, an importer which writes the garnishments to a central database, a transmitting component which sends the garnishments to participating garnishees, a second receiving component to receive responses to garnishments, a validation component to insure the responses meet basic standards of compliance and completeness, a business rules engine within the validation component to apply jurisdiction-specific standards to the validation, a second importer which writes the garnishee responses to the central database, and a second transmitting component.

### BRIEF DESCRIPTION OF THE DRAWINGS

FIG. 1A is a block diagram of a network for managing the delivery of a response to garnishments for a plurality of collection attorneys and garnishees, in accordance with an example embodiment.

FIG. 1B is a block diagram of an example of a central server, according to an example embodiment.

FIG. 2 is a flow chart illustrating the collection, standardization, validation and storage of garnishment data in a central database, according to an example embodiment.

FIG. 3 is a flow chart illustrating a method of reviewing and responding to garnishments, according to an example embodiment.

FIG. 4 is a flow chart illustrating a method of facilitating the automated electronic processing of garnishments by integrating with a system at a financial institution, employer, or other entity, according to an example embodiment.

FIG. 5 is a flow chart illustrating a method of reviewing and responding to garnishments, according to another example embodiment.

FIG. 6 is a block diagram of a computer system suitable for executing methods and implementing servers and clients, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one or more embodiments. The software may consist of computer executable instructions stored on computer readable media such as memory or other type of storage devices. Further, such functions correspond to modules, which are software stored on storage devices, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

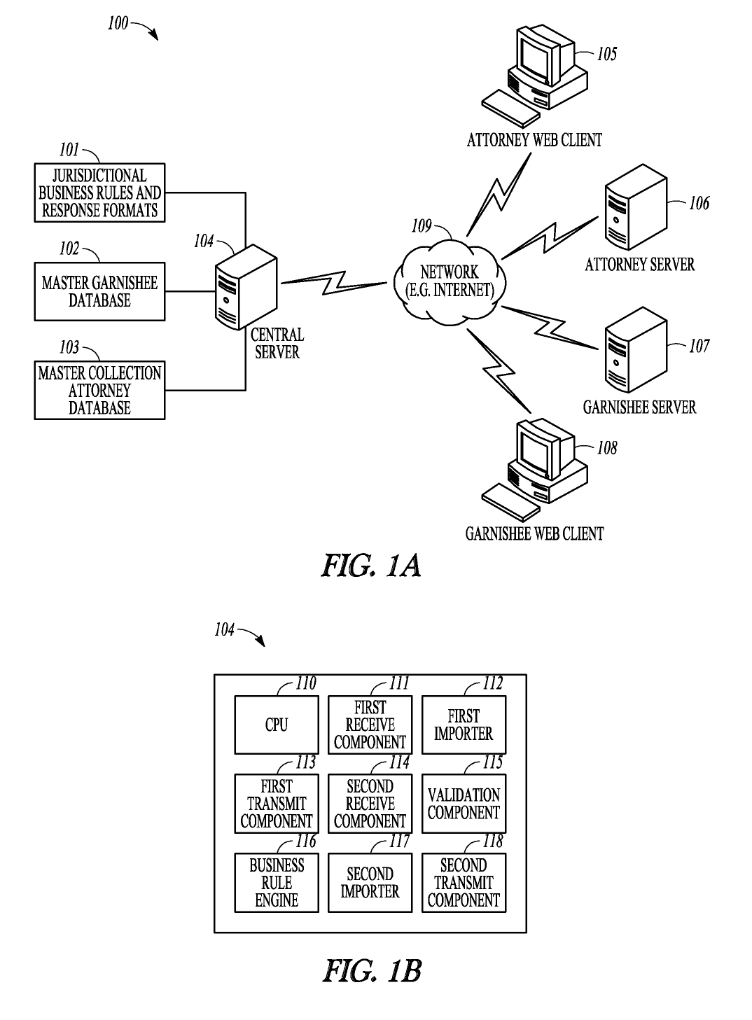

FIG. 1A depicts an example embodiment of a system 100 that can include a network 109 (e.g., the Internet) connecting one central server 104 with one or more servers operated by a plurality of collection attorneys 106, one or more servers operated by a plurality of garnishees 107, and manifold web clients used by collection attorneys 105 and garnishees 108. The central server 104 maintains a collection of cross-industry configuration data including jurisdiction-specific rules and document templates 101, a master database of garnishees 102, and a master database of collection attorneys 103.

In various embodiments, the garnishees are banks or financial institutions holding assets of a person who has a judgment against them. Garnishees may also include employers of such person. The garnishments are directed toward the assets, or wages earned, or to be earned, but not yet disbursed. The rules encapsulated at 101 may vary from state to state, and relate to whether or not garnishment may be limited by various constraints such as minimum wage or asset amounts, and other restrictions imposed by individual states. While the various constraints in each state are well known, it can be complex to determine the constraints when confronted with multiple garnishment requests for multiple employees or asset holders from different states.

FIG. 1B depicts an example of a central server 104 (e.g., a data processor at a central location), according to an example embodiment. The central server 104 can include a central processing unit 110, a first receiving component 111 to receive garnishments from submitters (e.g., garnishee 107 or collection attorney 106), an importer 112 to write the garnishments to a central database (e.g., a memory of the central server 104), a first transmitting component 113 to send the garnishments to participating garnishees 107. The central server 104 can include a second receiving component 114 to receive responses to garnishments, a validation component 115 to insure the responses meet basic standards of compliance and completeness, a business rules engine 116 within the validation component to apply jurisdiction-specific standards to the validation (e.g., jurisdiction-specific rules and document templates 101). The central server 104 can include a second importer 117 to write the responses to the central database, and a second transmitting component 118 to send completed responses to the original submitters of the garnishments.

At least one of the first or second receiving components 111 or 114 can be configured to receive batch files. At least one of the first or second receiving components 111 or 114 can implement a possibly interactive machine-to-machine communication protocol (e.g., can communicate over Ethernet, Transmission Control Protocol (TCP), Internet Protocol (IP), File Transfer Protocol (FTP), HyperText Transfer Protocol (HTTP), Simple Object Access Protocol (SOAP), a secure version thereof, a combination thereof, or other communication protocol that allows for transfer of data from one machine to another machine). At least one of the first or second receiving components 111 or 114 can receive direct user input via a user interface provided as part of the central server 104.

At least one of the first or second transmitting components 113 or 118 can be configured to transmit batch files. At least one of the first or second transmitting components 113 or 118 can be configured to implement a possibly interactive machine-to-machine communication protocol. At least one of the first or second transmitting components 113 or 118 can be configured to direct user input via a user interface provided as part of the central server 104.

The first receiving component 111 and the first transmitting component 113 can receive and transmit, respectively, data with an indicator to relate the electronic description of the garnishment to a paper version of the garnishment order. The paper version of the garnishment order can be conveyed to the garnishee, such as through sending an electronic copy of the paper version to the garnishee or mailing the paper version to the garnishee. Conveying the garnishment order to the garnishee can be accomplished via a separate system or as an attachment to or an enclosure that is part of an electronic communication to the garnishee.

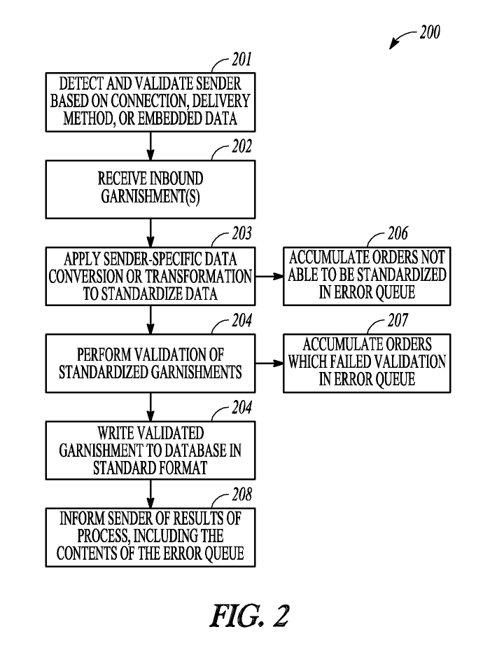

FIG. 2 depicts an example embodiment of a process 200 for aggregating garnishments in a central server. This process begins with the detection and validation of an authorized submitter of garnishments 201 by a plurality of potential methods including one or more of user credentials, access method, originating network location, or other such methods of user identification and validation which are known to those skilled in the art. After establishing an authorized and validated connection, inbound garnishments can be received 202 as individual orders or as a plurality of orders in a batch. Garnishments may be identified uniquely by a synthetic code comprised of two elements. The first element may be a central server 104 assigned code associated with a collection attorney 106 sending the garnishment. The second element of the synthetic code may be the collection attorney's internal code (aka file number) for the garnishment.

In one or more embodiments, the submitted garnishments can include data in at least two areas. A first area includes data elements that appear in a garnishment such as the name of the garnishee, an identifier such as the social security number of the person being subjected to garnishment, and other information as desired. The second area includes data elements that appear on the disclosure of the garnishment, such as the date of the response, who made the response, and the content of the response. The content of the response may be variable based on the nature of the response as well as the applicable jurisdiction. Other information may be included in further embodiments to aid with processing and tracking of the garnishments.

The submitted garnishments can be standardized via one or more methods of data conversion or transformation 203 any of which would be familiar to those skilled in the art. Submitted garnishments which are unable to be standardized 206 can be added to an error queue. The standardized garnishments can be validated 204 against a set of general rules as well as rules specific to the jurisdiction of the specific garnishment order. Submitted garnishments which are unable to be validated 207 can be added to the error queue. Validated garnishments can then be written to the garnishment database 205. At 208, the system can transmit the results of the process to the original sender of the garnishment orders, including the contents, if any, of the error queue.

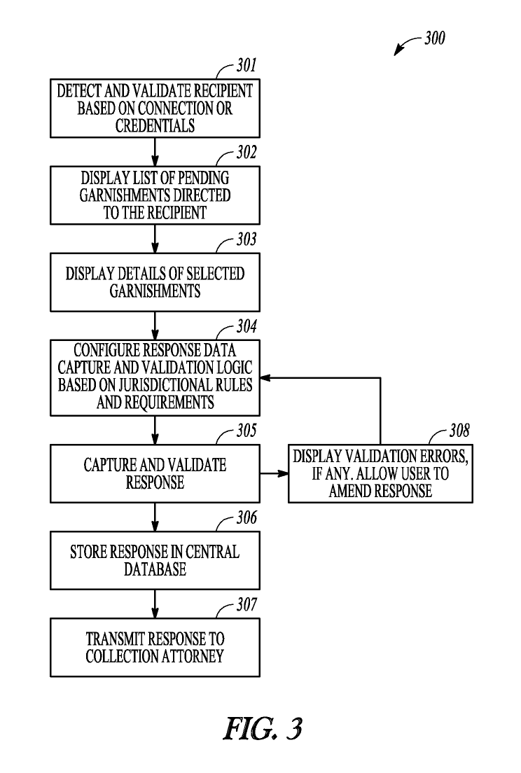

FIG. 3 depicts one or more embodiments of a process 300 for a garnishee to receive garnishments and respond to those orders via a web client such as a browser. This process can begin with the detection and validation of an authorized responder to garnishments 301 by a plurality of potential methods including one or more of user credentials, access method, originating network location, or other such methods of user identification and validation which are known to those skilled in the art. The user can then be presented with 302 a list of pending garnishments directed to the entity with which the active user is affiliated. By activating an item from this list the user can be presented with 303 the details of that garnishment and controls for responding to the garnishment. The system can dynamically configure the display and data capture elements of the response screen 304 based on jurisdiction-specific rules and requirements. The user can complete the response form and submit it 305 after which time the response can be validated and the user can be provided an opportunity 308 to amend the responses if the validation failed, after which time the can could be resubmitted. If this response was successfully validated, the response can be stored in the central database 306. The response can be transmitted to the applicable collection attorney 307, such as through the electronic network shown in FIG. 1.

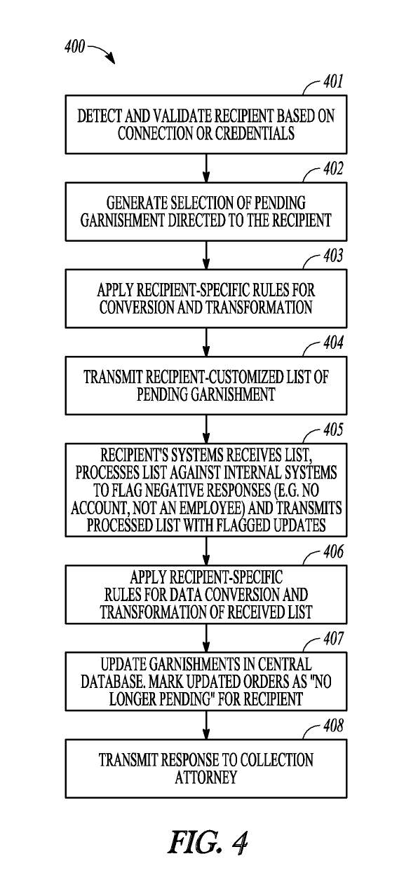

FIG. 4 depicts one or more embodiments of a process 400 for a garnishee to receive garnishments and respond to those orders via machine-to-machine communication. This process can begin with the detection and validation of an authorized responder to garnishments 401 by a plurality of potential methods including one or more of user credentials, access method, originating network location, or other such methods of user identification and validation which are known to those skilled in the art. In response thereto, the system can 402 generate a selection of pending garnishments directed to the recipient and 403 apply any recipient-specific conversions or transformations of the data to facilitate processing by the recipient. The system can, after such time. 404 transmit the recipient-specific electronic representation of the pending garnishment orders. The recipient's systems can 405 process the pending garnishments against the recipient's other internal systems to automatically apply so-called “negative responses” to applicable garnishments and can transmit the processed results back to the central server 104. The central server 104 can then 406 apply a recipient-specific transformation to the response received to allow for standardized processing. The central server 104 then 407 process these standardized responses by updating a central database (e.g., the jurisdiction-specific rules and document templates 101, the master database of garnishees 102, or the master database of collection attorneys 103 of FIG. 1) with the responses, including marking garnishments thus responded to as no longer pending, such that they will not be presented for further processing by the garnishee 107. Finally, the response will be transmitted 408 to the applicable collection attorney 106 via the electronic network.

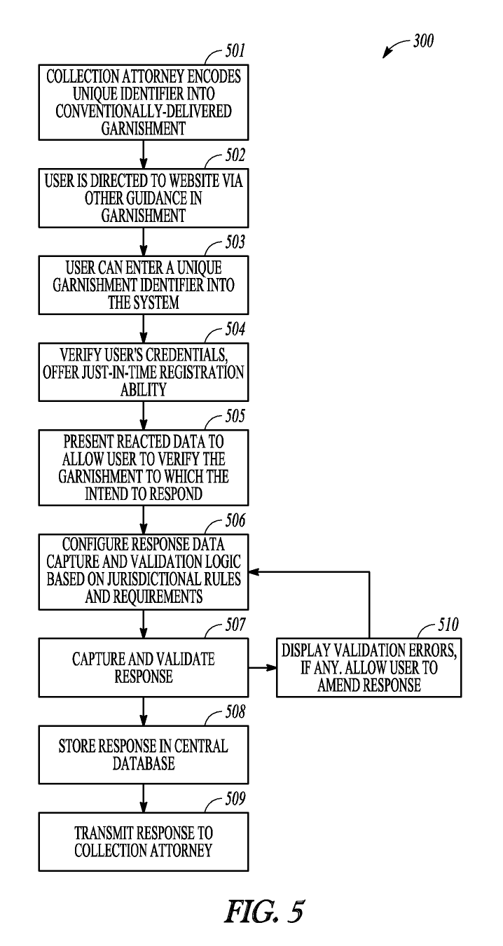

FIG. 5 depicts one or more embodiments of a process 500 for a garnishee 107 to respond to garnishments via a web client such as a browser. This process can begin 501 with a collection attorney 107 attaching a unique garnishment identifier to garnishments being delivered by conventional processes such as postal mail. The recipient garnishee can visit the website to which they are directed 502 in other narrative on the garnishment or attached cover material. The recipient garnishee can then 503 enter the unique garnishment identifier at the website and submit it to the central server 104. The user's credentials can be requested and verified if they had not already logged into the system 504. If the user does not have login credentials, they can be provided a registration facility to establish those credentials, such as quick and efficiently. If a matching garnishment exists in the central server 104, the user can be presented with redacted information about the individual toward whom the garnishment is directed to allow the garnishee to verify that they are responding to the correct garnishment 505. The system can dynamically configure the display and data capture elements of the response screen 506 based on jurisdiction-specific rules and requirements. The user can complete the response form and submit it 507 after which time the response can be validated and the user can be provided an opportunity 510 to amend the responses if the validation failed, after which time the response can be resubmitted. If this response was successfully validated, the response can be stored in the central database 508. The response can be transmitted 509 to the applicable collection attorney 106 via the electronic network (e.g., one or more items of the system 100 shown in FIG. 1).

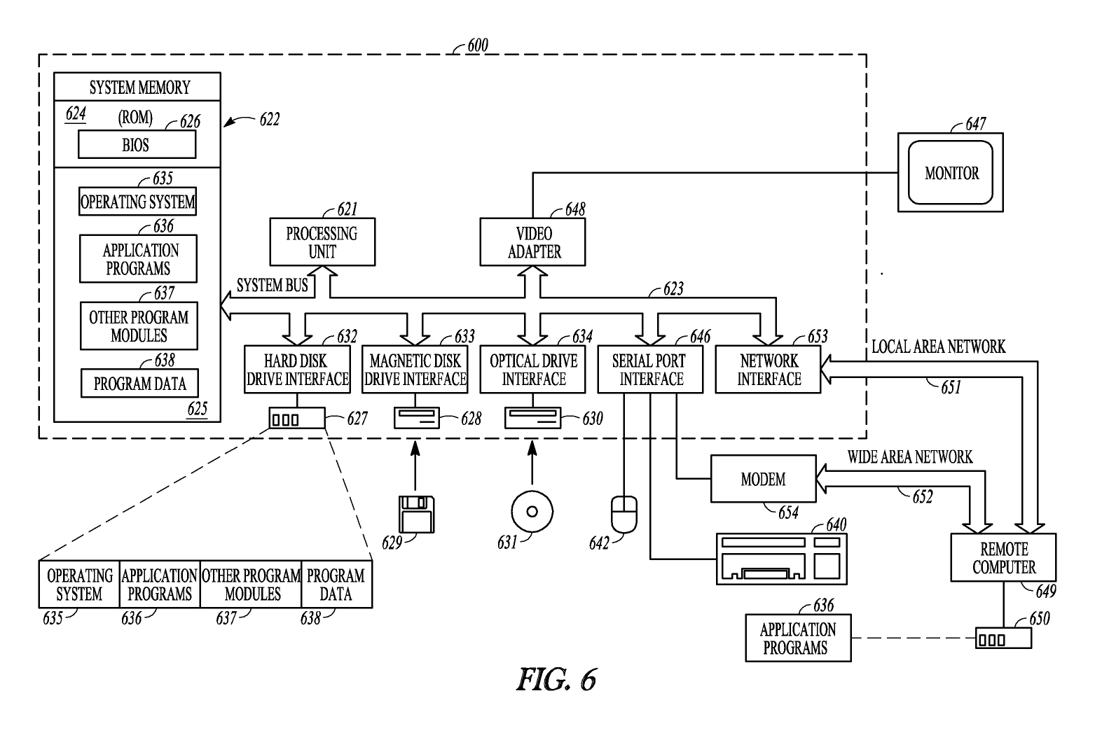

FIG. 6 is a block diagram of a computer system 600 to implement the described methods, according to an example embodiment. Any of the servers or computers mentioned herein In the embodiment shown in FIG. 6, a hardware and operating environment is provided that can be applicable to any of the servers and clients shown in the other Figures. All the components shown in FIG. 6 need not be included in various implementations.

As shown in FIG. 6, one or more embodiments of the hardware and operating environment can include a general purpose computing device in the form of a computer 600 (e.g., a personal computer, workstation, or server), including one or more processing units 621, a system memory 622, and a system bus 623 that operatively couples various system components including the system memory 622 to the processing unit 621. There may be only one or there may be more than one processing unit 621, such that the processor of computer 600 comprises a single central-processing unit (CPU), or a plurality of processing units, commonly referred to as a multiprocessor or parallel-processor environment. In various embodiments, computer 600 can be a conventional computer, a distributed computer, or any other type of computer.

The system bus 623 can be any of several types of bus structures including a memory bus or memory controller, a peripheral bus, and a local bus using any of a variety of bus architectures. The system memory can also be referred to as simply the memory, and, in some embodiments, includes read-only memory (ROM) 624 and random-access memory (RAM) 625. A basic input/output system (BIOS) program 626, containing the basic routines that help to transfer information between elements within the computer 600, such as during start-up, may be stored in ROM 624. The computer 600 can further includes a hard disk drive 627 for reading from and writing to a hard disk, not shown, a magnetic disk drive 628 for reading from or writing to a removable magnetic disk 629, and an optical disk drive 630 for reading from or writing to a removable optical disk 631 such as a CD ROM or other optical media.

The hard disk drive 627, magnetic disk drive 628, and optical disk drive 630 couple with a hard disk drive interface 632, a magnetic disk drive interface 633, and an optical disk drive interface 634, respectively. The drives and their associated computer-readable media can provide nonvolatile storage of computer-readable instructions, data structures, program modules and other data for the computer 600. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the operating environment.

A plurality of program modules can be stored on the hard disk, magnetic disk 629, optical disk 631, ROM 624, or RAM 625, including an operating system 635, one or more application programs 636, other program modules 637, and program data 638. Programming for implementing one or more processes or method described herein may be resident on any one or number of these computer-readable media.

A user may enter commands and information into computer 600 through input devices such as a keyboard 640 and pointing device 642. Other input devices (not shown) can include a microphone, joystick, game pad, satellite dish, scanner, or the like. These other input devices can be connected to the processing unit 621 through a serial port interface 646 that is coupled to the system bus 623, but can be connected by other interfaces, such as a parallel port, game port, or a universal serial bus (USB). A monitor 647 or other type of display device can be connected to the system bus 623 via an interface, such as a video adapter 648. The monitor 647 can display a graphical user interface for the user. In addition to the monitor 647, computers typically include other peripheral output devices (not shown), such as speakers and printers.

The computer 600 may operate in a networked environment using logical connections to one or more remote computers or servers, such as remote computer 649. These logical connections are achieved by a communication device coupled to or a part of the computer 600; the disclosure is not limited to a particular type of communications device. The remote computer 649 can be another computer, a server, a router, a network PC, a client, a peer device or other common network node, and typically includes many or all of the elements described above I/O relative to the computer 600, although only a memory storage device 650 has been illustrated. The logical connections depicted in FIG. 6 include a local area network (LAN) 651 and/or a wide area network (WAN) 652. Such networking environments are commonplace in office networks, enterprise-wide computer networks, intranets and the internet, which are all types of networks.

When used in a LAN-networking environment, the computer 600 is connected to the LAN 651 through a network interface or adapter 653, which is one type of communications device. In some embodiments, when used in a WAN-networking environment, the computer 600 can include a modem 654 (another type of communications device) or any other type of communications device, e.g., a wireless transceiver, for establishing communications over the wide-area network 652, such as the internet. The modem 654, which may be internal or external, can be connected to the system bus 623 via the serial port interface 646. In a networked environment, program modules depicted relative to the computer 600 can be stored in the remote memory storage device 650 of remote computer, or server 649. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

### ADDITIONAL NOTES AND EXAMPLES

In Example 1, a data processor at a central location includes a central processing unit and a receiving component to receive garnishments from submitters.

In Example 2, the data processor of Example 1 includes an importer to write the garnishments to a central database.

In Example 3, the data processor of at least one of Examples 1-2 includes a transmitting component to send the garnishments to participating garnishees.

In Example 4, the data processor at least one of Examples 1-3 includes a second receiving component to receive responses to garnishments.

In Example 5, the data processor of at least one of Examples 1-4 includes a validation component to insure the responses meet basic standards of compliance and completeness.

In Example 6, the data processor of at least one of Examples 1-5 includes a business rules engine within the validation component to apply jurisdiction-specific standards to the validation.

In Example 7, the data processor of at least one of Examples 1-6 includes a second importer to write the responses to the central database.

In Example 8, the data processor of at least one of Examples 1-7 includes a second transmitting component to send completed responses to the original submitters of the garnishments.

In Example 9, the first or second receiving components of at least one of Examples 1-8 is configured to receive batch files.

In Example 10, the first or second receiving components of at least one of Examples 1-9 is configured to implement interactive machine-to-machine communication.

In Example 11, the first or second receiving components of at least one of Examples 1-10 is configured to receive direct user input via a user interface provided as part of the data processor.

In Example 12, the first or second transmitting components of at least one of Examples 1-11 is configured to receive batch files.

In Example 13, the first or second transmitting components of at least one of Examples 1-12 is configured to implement interactive machine-to-machine communication.

In Example 14, at least one of the first or second transmitting components of at least one of Examples 1-13 is configured to transmit direct user input via a user interface provided as part of the data processor.

In Example 15, the first receiving and first transmitting components of at least one of Examples 1-14 are configured to receive and transmit data with an indicator to relate the electronic description of the garnishment to a paper version of the garnishment order.

In Example 16, the first receiving and first transmitting components of at least one of Examples 1-15 are configured to receive and transmit data with an indicator to relate the electronic description of the garnishment to an electronic version of the garnishment order which is conveyed to the garnishee by a separate system.

In Example 17, the first receiving and first transmitting components of at least one of Examples 1-16 is configured to receive and transmit data with an indicator to relate the electronic description of the garnishment to an electronic version of the garnishment which is conveyed to the garnishee as an enclosure of the system.

In Example 18 a method includes receiving garnishments at a server from network coupled submitters, writing the garnishments to a central database, transmitting the garnishments to participating garnishees via a network, receiving responses to garnishments from responders via the network, validating the responses to ensure they meet basic standards of compliance and completeness, applying jurisdiction-specific standards to the validation via the server, writing the garnishee responses to the central database, and sending completed garnishee responses to the original submitters of the garnishments.

In Example 19, the method of at least one of Examples 1-18 includes receiving a query regarding a garnishment from an original submitter of the garnishment, and providing a status of the garnishment to the original submitter responsive to the query.

In Example 20, the method of at least one of Examples 1-19 includes identifying garnishments by a code having an element identifying the original submitter and an element including an original submitter assigned file number.

In Example 21, the garnishment of at least one of Examples 1-20 includes information uniquely identifying the garnishee and a date of the response and identity of the responder.

In Example 22, a system includes a server coupled to a network, the server configured to store garnishment requests from multiple garnishment originators, provide the requests to multiple garnishees, and receive responses from the multiple garnishees via the network.

In Example 23, the system of at least one of Examples 1-22 a rules engine stored on a machine readable storage device to provide jurisdiction dependent garnishment rules for responses.

In Example 24, the server of at least one of Examples 1-23 is further configured to provide information regarding each garnishment to the corresponding originator and responder via the network.

In Example 25, the server of at least one of Examples 1-24 is further configured to receive and store information from the garnishee regarding collection of funds related to the garnishments.

In Example 26, the server of at least one of Examples 1-25 is configured to verify that the originator is a valid originator before storing the garnishment request received from the originator.

In Example 27, verifying that the originator is a valid originator of at least one of Examples 1-26 includes verifying the originator's credentials.

In Example 28, verifying that the originator is a valid originator of at least one of Examples 1-27 includes verifying a network location that originated the originator's request originated from is a valid network location from which to receive the garnishment request.

In Example 29, the server of at least one of Examples 1-28 includes a collection attorney database including data identifying collection attorneys authorized to access data on the server.

In Example 30, the server of at least one of Examples 1-29 includes a garnishee database including data identifying garnishees authorized to access data on the server.

Some embodiments implement the functions in two or more specific interconnected hardware modules or devices with related control and data signals communicated between and through the modules, or as portions of an application-specific integrated circuit. Thus, the exemplary process flows are applicable to software, firmware, and hardware implementations.

Systems and methods of the present disclosure may be implemented on a mobile device as a mobile application, web-based application, on a desktop computer as a computer application, or a combination thereof. A mobile application may operate on a Smartphone, tablet computer, portable digital assistant (PDA), ruggedized mobile computer, or other mobile device. The mobile device may be connected to the Internet or network via Wi-Fi, Wide Area Network (WAN), cellular connection, WiMax, or any other type of wired or wireless method of networking connection. In some embodiments, a web-based application may be delivered as a software-as-a-service (SaaS) package (e.g. cloud-based embodiments) accessible via a device app, a web browser application, or other suitable application, depending on the particular embodiment.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A data processor at a central location comprising:
a central processing unit;
a first receive component to receive garnishments from submitters;
a first importer to write the garnishments to a central database;
a transmit component to send the garnishments to participating garnishees;
a second receive component to receive responses to garnishments;
a validation component to insure the responses meet basic standards of compliance and completeness;
a business rules engine within the validation component to apply jurisdiction-specific standards to the validation;
a second importer to write the responses to the central database; and
a second transmit component to send completed responses to the original submitters of the garnishments.

2. The data processor of claim 1, wherein at least one of the first or second receive components is configured to receive batch files.

3. The data processor of claim 1, wherein at least one of the first or second receive components is configured to implement a machine-to-machine communication protocol.

4. The data processor of claim 1, wherein at least one of the first or second receive components is configured to receive direct user input via a user interface provided as part of the data processor.

5. The data processor of claim 1, wherein at least one of the first or second transmit components is configured to transmit batch files.

6. The data processor of claim 1, wherein at least one of the first or second transmit components is configured to implement a machine-to-machine communication protocol.

7. The data processor of claim 1 wherein at least one of the first or second transmit components is configured to transmit direct user input via a user interface provided as part of the data processor.

8. The data processor of claim 1 wherein the first receive and transmit components receive and transmit data with an indicator to relate the electronic description of the garnishment to a paper version of the garnishment.

9. The data processor of claim 1 wherein the first receive and transmit components receive and transmit data with an indicator to relate the electronic description of the garnishment to an electronic version of the garnishment.

10. The data processor of claim 9 wherein the first receive and transmit components receive and transmit data with an indicator to relate the electronic description of the garnishment to an electronic version of the garnishment and convey the electronic version of the garnishment to the garnishee as an attachment to an electronic communication.

11. A method comprising:
receiving garnishments at a server from network coupled submitters;
writing the garnishments to a central database;
transmitting the garnishments to participating garnishees via the network;
receiving responses to garnishments from responders via the network;
validating the responses to ensure they meet basic standards of compliance and completeness;
applying jurisdiction-specific standards to the validation via the server;
writing the garnishee responses to the central database; and
sending completed garnishee responses to the original submitters of the garnishments.

12. The method of claim 11 and further comprising:
receiving a query regarding a garnishment from an original submitter of the garnishment; and
providing a status of the garnishment to the original submitter responsive to the query.

13. The method of claim 11 and further comprising identifying garnishments by a code having an element identifying the original submitter and an element including an original submitter assigned file number.

14. The method of claim 11 wherein the garnishment includes information uniquely identifying the garnishee and a date of the response and identity of the responder.

15. A system comprising:
a server coupled to a network, the server configured to store garnishment requests from multiple garnishment originators, provide the requests to multiple garnishees, and receive responses from the multiple garnishees via the network;
a rules engine stored on a machine readable storage device to provide jurisdiction dependent garnishment rules for responses; and
wherein the server is further configured to provide information regarding each garnishment to the corresponding originator and responder via the network.

16. The system of claim 15 wherein the server is further configured to receive and store information from the garnishee regarding collection of funds related to the garnishments.

17. The system of claim 15, wherein the server is configured to verify that the originator is a valid originator before storing the garnishment request received from the originator.

18. The system of claim 17, wherein verifying that the originator is a valid originator includes verifying the originator's credentials.

19. The system of claim 17, wherein verifying that the originator is a valid originator includes verifying a network location that originated the originator's request originated from.

20. The system of claim 15, further comprising:
a collection attorney database including data identifying collection attorneys authorized to access data on the server; and
a garnishee database including data identifying garnishees authorized to access data on the server.
